(19) United States
(12) Patent Application Publication
(10) Pub. No.: US 2025/0298762 A1
(43) Pub. Date: Sep. 25, 2025

(54) DYNAMIC CONTROL OF LINK SPEEDS IN PHY

(71) Applicant: Micron Technology, Inc., Boise, ID (US)

(72) Inventors: Joseph L. Turmes, Nampa, ID (US); Dave Holmstrom, Los Gatos, CA (US); John Maroney, Irvine, CA (US)

(21) Appl. No.: 19/086,880

(22) Filed: Mar. 21, 2025

Related U.S. Application Data
(60) Provisional application No. 63/568,159, filed on Mar. 21, 2024.

(51) Int. Cl. G06F 13/20

(52) U.S. Cl. CPC G06F 13/20; G06F 2213/40

(57) ABSTRACT

A physical link comprising a set of lanes is configured according to a first lane configuration. In the first lane configuration, a first portion of the set of lanes is disabled and a second portion of the set of lanes serves traffic at a first link speed. A processing device, operatively coupled to the physical link, detects a change to bandwidth utilization of the physical link. In response to detecting the change to bandwidth utilization of the physical link, the processing device configures the set of lanes according to a second lane configuration. In configuring the set of lanes, the processing device configures the first portion of the set of lanes to serve traffic at a second link speed and disables the second portion of the set of lanes.

### PRIORITY APPLICATION

This application claims the benefit of priority to U.S. Provisional Application Ser. No. 63/568,159, filed Mar. 21, 2024, which is incorporated herein by reference in its entirety.

### TECHNICAL FIELD

Embodiments of the disclosure relate generally to memory sub-systems and, more specifically, to techniques for dynamically controlling link speeds in a physical layer (PHY) of a host interface.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory sub-system to store data at the memory components and to retrieve data from the memory components.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a memory sub-system, in accordance with some embodiments of the present disclosure.

FIGS. 2A-2E are conceptual diagrams illustrating interactions among components in the memory sub-system in performing a method for dynamically controlling link speeds in a physical layer of a host interface of the memory sub-system, in accordance with some embodiments of the present disclosure.

FIGS. 3A and 3B are flow diagrams illustrating an example method for dynamically controlling link speeds in a physical layer of a host interface a computing sub-system, in accordance with some embodiments of the present disclosure.

FIG. 4 is a block diagram of an example computer system in which embodiments of the present disclosure may operate.

### DETAILED DESCRIPTION

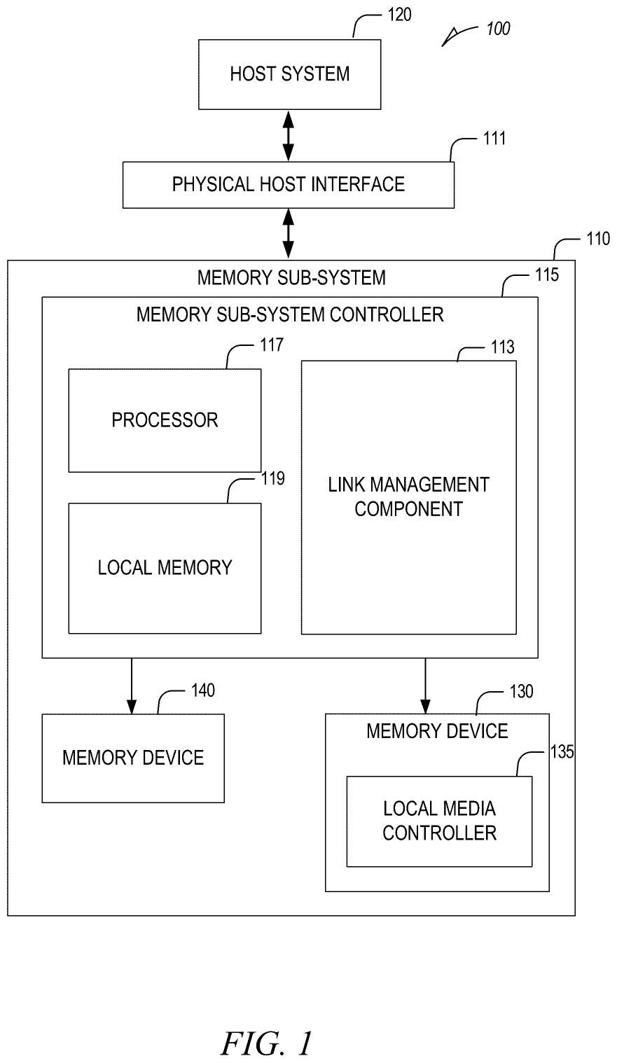

Aspects of the present disclosure are directed to an approach for dynamically controlling link speeds in a physical layer (PHY) of a host interface of a computing sub-system. In an example, the computing sub-system is a memory sub-system. A memory sub-system can be a storage device (e.g., SSD), a memory module, or a combination of a storage device and memory module. Examples of storage devices and memory modules are described below in conjunction with FIG. 1.

A memory device can be a non-volatile memory device. One example of a non-volatile memory device is a negative-and (NAND) memory device. In general, a host system can utilize a memory sub-system that includes one or more components, such as memory devices that store data. The host system is communicatively coupled to the memory sub-system via a host interface that includes a physical link such as a Peripheral Component Interconnect Express (PCIe) interface. For example, the host system can provide data to be stored at the memory sub-system via the host interface and can request data to be retrieved from the memory sub-system via the host interface. A memory sub-system controller typically receives commands or operations from the host system via the host interface and converts the commands or operations into instructions or appropriate commands to achieve the desired access to the memory components of the memory sub-system.

Given the critical role of the host interface, its link speeds are an important factor in the performance capabilities of NAND memory devices. As these speeds increase, so too does the power consumed by the Physical Layer (PHY) of the interface. As an example, the increase in link speeds of PCIe interfaces at each new generation is accompanied by an increase in power consumption by the PHY of the interface, as illustrated below in Table 1.

TABLE 1

| | Bandwidth | | Max | | |
|---|---|---|---|---|---|
| PCIe | per Lane | Power per | Bandwidth | Max PHY | |
| Gen. | (GB/s) | Lane (W) | (GB/s) | Power (W) | GB/s/Watt |
| 7 | 15.13 | 4 | 60.52 | 16 | 3.7825 |
| 6 | 7.56 | 1 | 30.24 | 4 | 7.56 |
| 5 | 3.94 | 0.25 | 15.76 | 1 | 15.76 |
| 4 | 1.97 | 0.0625 | 7.88 | 0.25 | 31.52 |
| 3 | 0.985 | 0.015625 | 3.94 | 0.0625 | 63.04 |

As shown in Table 1, despite enhancements aimed at improving power efficiency, the power consumption associated with the PHY continues to rise, thus presenting a challenge for maintaining the performance of NAND devices without incurring negative impacts due to increased power draw and associated thermal effects.

The PCIe specification, particularly in its sixth generation (Gen 6), has introduced a feature that allows for dynamic enabling and disabling of unused PCIe communication lanes. This feature is designed to conserve power when the full bandwidth of the PCIe link is not being utilized. However, the current implementations of power-saving measures are limited in their effectiveness during active data flow, as they do not account for the varying degrees of bandwidth utilization that occur in real-world applications.

In practice, workloads such as those encountered in data centers do not always require the maximum bandwidth provided by the latest PCIe generations. This underutilization presents an opportunity for power savings if the interface can be dynamically adjusted to match the actual bandwidth being consumed.

Aspects of the present disclosure address the above and other issues by dynamically adjusting link speeds of a physical host interface on a per-lane basis. More specifically, a link management component of a computing sub-system (e.g., a memory sub-system) adjusts link speeds of individual lanes within a physical host interface, such as a PCIe interface, based on real-time bandwidth utilization of the interface. By enabling each lane to operate at an independent link speed, the system can optimize power consumption based on actual bandwidth utilization of the physical host interface at any given moment, thereby reducing unnecessary power usage and improving overall energy efficiency. This approach contrasts with conventional techniques that treat all lanes as a single unit, lacking the flexibility to adjust to varying data demands. Dynamically controlling link speeds in the manner described herein allows for a more responsive and adaptive power management strategy that aligns with the dynamic nature of data center workloads and other applications where bandwidth needs can fluctuate significantly over time.

The ability to dynamically adjust the link speed of individual lanes allows for significant power savings, especially in scenarios where full bandwidth is not required. This leads to more energy-efficient operations and can contribute to lower operational costs, particularly in large-scale deployments. Reducing power consumption in this manner also mitigates the thermal output of devices that communicate with the host system via the physical host interface, which can enhance the reliability and longevity of such devices by minimizing the risk of overheating and avoiding thermal throttling, which can degrade performance. The techniques for controlling link speeds described herein also allow for lanes to be kept active at lower speeds during idle periods, which can significantly reduce the latency when the device needs to return to active data service. This is particularly beneficial for applications that require quick data access after idle periods. In addition, in certain workloads, especially those with complex mixed operations, dynamically controlling link speeds can improve QoS by reducing the “burstiness” of IOs across the physical host interface, thereby resulting in more consistent performance without impacting throughput.

FIG. 1 illustrates an example computing environment 100 that includes a memory sub-system 110, in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a SSD, a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing environment 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, and so forth.

The host system 120 can be a computing device such as a desktop computer, laptop computer, network server, mobile device, embedded computer (e.g., one included in a vehicle, industrial equipment, or a networked commercial device), or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface 111. Examples of a physical host interface 111 include, but are not limited to, a serial advanced technology attachment (SATA) interface, a peripheral component interconnect express (PCIe) interface, a compute express link (CXL) interface, a USB interface, a Fibre Channel interface, a Serial Attached SCSI (SAS) interface, and so forth. The physical host interface 111 can be used to transmit data between the host system 120 and the memory sub-system 110. The host system 120 can further utilize a Non-Volatile Memory Express (NVMe) interface to access the memory devices 130 and 140 when the memory sub-system 110 is coupled with the host system 120 by the PCIe or CXL interface. The physical host interface 111 provides physical link with multiple communication lanes (also referred to herein simply as “lanes”) for passing control, address, data, and other signals between the memory sub-system 110 and the host system 120.

The memory devices can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

An example of non-volatile memory devices (e.g., memory device 130) includes a NAND type flash memory. Each of the memory devices 130 can include one or more arrays of memory cells such as SLCs, multi-level cells (MLCs) (e.g., TLCs, or quad-level cells (QLCs)). In some embodiments, a particular memory component can include an SLC portion, and an MLC portion, a TLC portion, or a QLC portion of memory cells. Each of the memory cells can store one or more bits of data used by the host system 120. Furthermore, the memory cells of the memory devices 130 can be grouped as memory pages or memory blocks that can refer to a unit of the memory component used to store data.

Although non-volatile memory components such as NAND type flash memory are described, the memory device 130 can be based on any other type of non-volatile memory, such as read-only memory (ROM), phase change memory (PCM), magneto random access memory (MRAM), NOR flash memory, electrically erasable programmable read-only memory (EEPROM), and a cross-point array of non-volatile memory cells. A cross-point array of non-volatile memory can perform bit storage based on a change of bulk resistance in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased.

A memory sub-system controller 115 can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, and the like. The local memory 119 can also include ROM for storing micro-code. While the example memory sub-system 110 in FIG. 1 has been illustrated as including the memory sub-system controller 115, in another embodiment of the present disclosure, a memory sub-system 110 may not include a memory sub-system controller 115, and may instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical block address and a physical block address that are associated with the memory devices 130. The memory sub-system controller 115 can further include host interface circuitry to communicate with the host system 120 via the physical host interface 111. The host interface circuitry can convert the commands received from the host system into command instructions to access the memory devices 130 and convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130.

The memory sub-system 110 also includes a link management component 113 that is responsible for managing lane configurations in the physical link of the host interface 111. In managing lane configurations, the link management component 113 adjusts link speeds of the physical link on a per lane basis. That is, the link management component 113 manage link speeds of each individual lane of the physical interface such that lanes within the physical link can serve traffic at different link speeds depending on detected changes to bandwidth utilization of the physical link. Further details regarding the operation of the link management component 113 are discussed below.

In some embodiments, the memory sub-system controller 115 includes at least a portion of the link management component 113. For example, the memory sub-system controller 115 can include a processor 117 (processing device) configured to execute instructions stored in local memory 119 (e.g., firmware) for performing the operations described herein. In some embodiments, the link management component 113 is part of the host system 120, an application, or an operating system. Further details regarding the link management component 113 are discussed below.

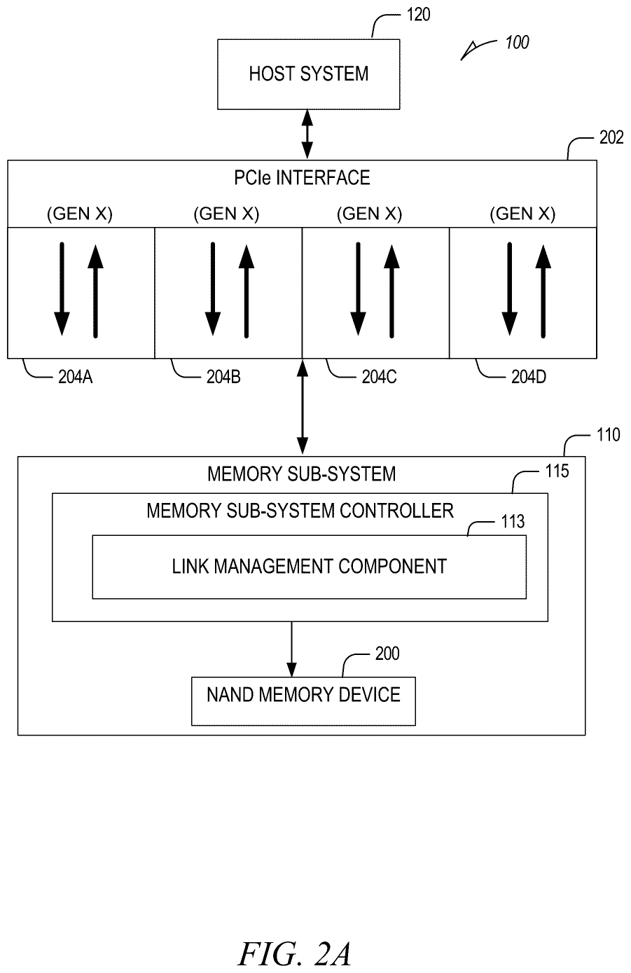

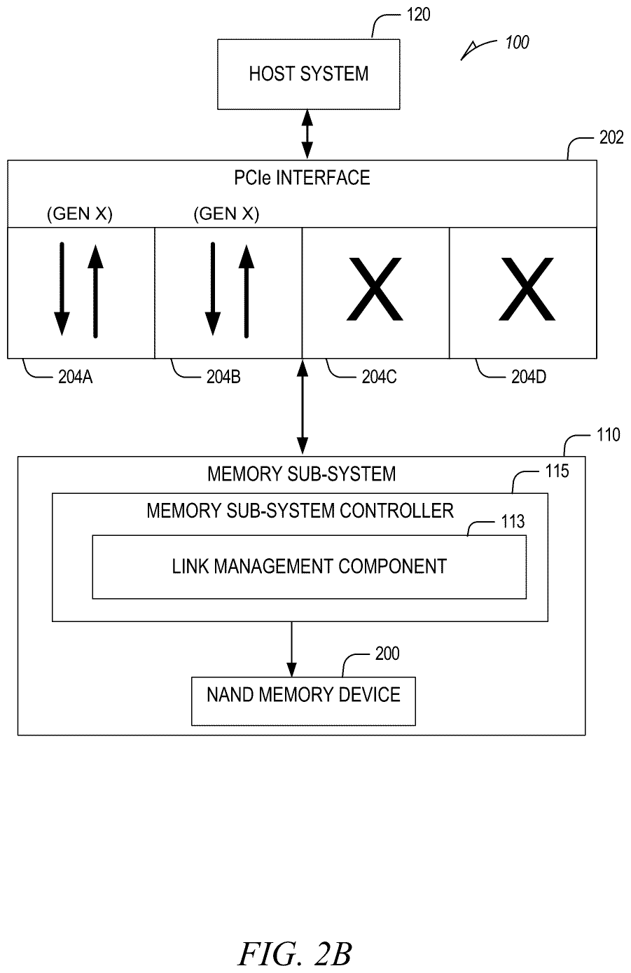

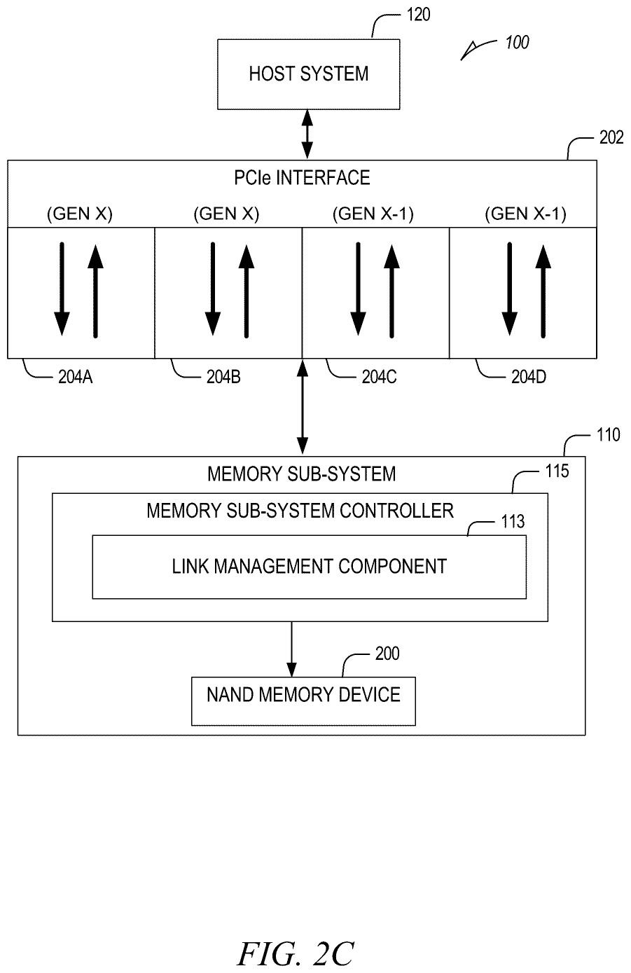

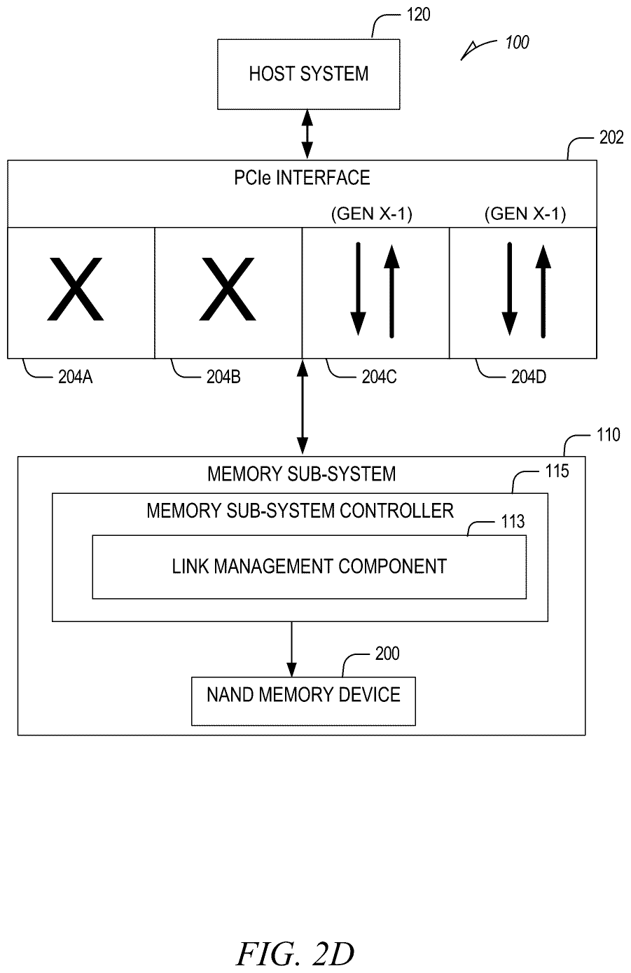

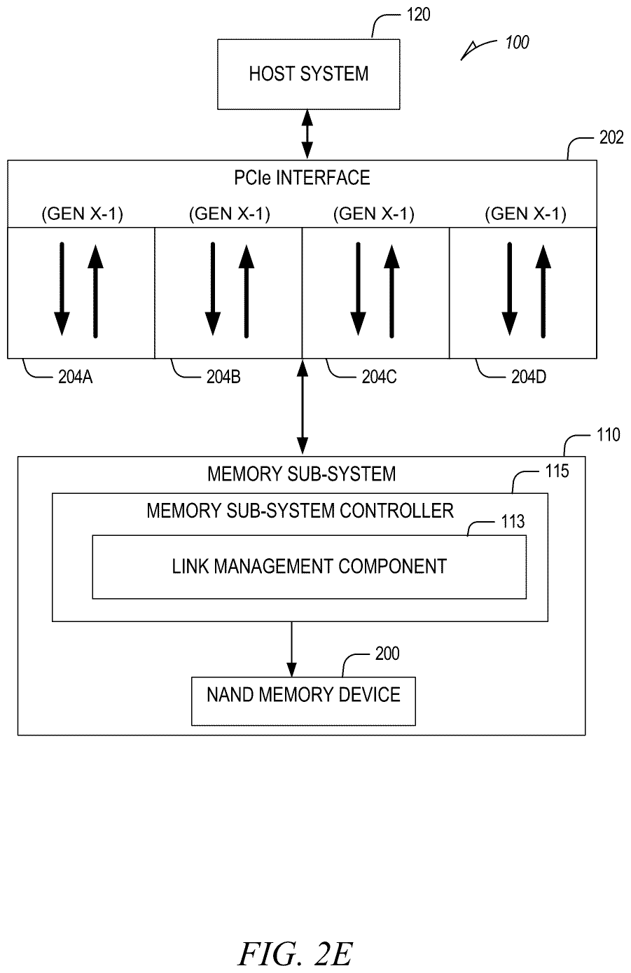

FIGS. 2A-2E are conceptual diagrams illustrating interactions between components in the memory sub-system in performing a method for dynamically controlling link speeds in a physical layer of the memory sub-system, in accordance with some embodiments of the present disclosure. In the example illustrated in FIGS. 2A-2E, NAND memory device 200 is an example memory device 130.

The NAND memory device 200 includes multiple NAND dies. Each die may include one or more planes and each plane includes multiple blocks. Each block includes a two- or three-dimensional array that includes pages (rows) and strings (columns). A string includes a plurality of memory cells connected in series. Each memory cell is used to represent one or more bit values. For example, a single NAND flash cell includes a transistor that stores an electric charge on a memory layer that is isolated by oxide insulating layers above and below. Within each cell, data is stored as the Vt of the transistor. SLC NAND, for example, can store one bit per cell. Other types of memory cells, such as MLCs, TLCs, QLCs, and penta-level cells (PLCs), can store multiple bits per cell.

In the example illustrated by FIGS. 2A-2E, the host system 120 is coupled to the memory sub-system 110 via a PCIe interface 202, which is an example physical host interface 111. In this example, the PCIe interface 202 includes four lanes-lanes 204A-204D.

With reference to FIG. 2A, the PCIe interface 202 is initially configured by the link management component 113 according to a first lane configuration that provides maximum power and performance for the PCIe interface 202. In the first lane configuration, each of the lanes 204A-204D is configured to serve traffic between the host system 120 and the memory sub-system 110 at a first link speed that corresponds to PCIe Gen X speeds (e.g., one of the speeds referenced above in TABLE 1), which allow up to 32 GB/s at 25 W for certain devices. The first lane configuration is a valid configuration for when bandwidth utilization of the PCIe interface 202 is between 16 GB/s and 32 GB/s.

Upon detecting a decrease to the bandwidth utilization of the PCIe interface 202 (e.g., below 16 GB/s), the link management component 113 may transition the PCIe interface 202 to another lane configuration to address the changes to bandwidth utilization. As an example, with reference to FIG. 2B, the link management component 113 may configure the PCIe interface 202 according to a second lane configuration in which a first portion of the lanes of the PCIe interface 202 (lanes 204A and 204B) continue to serve traffic at the first link speed (Gen X) while a second portion of the lanes (lanes 204C and 204D) is disabled to save power.

As another example, the link management component 113 may configure the PCIe interface 202 according to a third lane configuration in which each of the lanes 204A-204D is configured to serve traffic at a second link speed that corresponds to PCIe Gen X-1 speeds, which is slower than the Gen X speeds (the first link speed).

As shown in FIG. 2C, to transition the PCIe interface 202 from the second lane configuration to the third lane configuration, the link management component 113 configures the idle second portion of lanes (lanes 204C and 204D) to serve traffic at the second link speed (Gen X-1) while maintaining the first portion of lanes (lanes 204A and 204B) at the first link speed (Gen X), which results in a fourth lane configuration.

Subsequently, as shown in FIG. 2D, the link management component 113 disables the lanes 204A and 204B while maintaining the lanes 204C and 204D at the second link speed (Gen X-1) thereby resulting in a fifth lane configuration. To complete the transition to the third lane configuration, the link management component 113 configures the lanes 204A and 204B to serve traffic at the second link speed (Gen X-1) along with lanes 204C and 204D, as shown in FIG. 2E.

Although the examples illustrated in FIGS. 2A-2E address adjustments to link speeds for two lanes of the PCIe interface 202 at a time, it shall be appreciated that the link management component 113 adjusts link speeds on a per-lane basis; thus, the link management component 113 is not limited to performing speed adjustments on any particular number of lanes, and in other examples, the link management component 113 adjusts link speeds of only a single lane at a time.

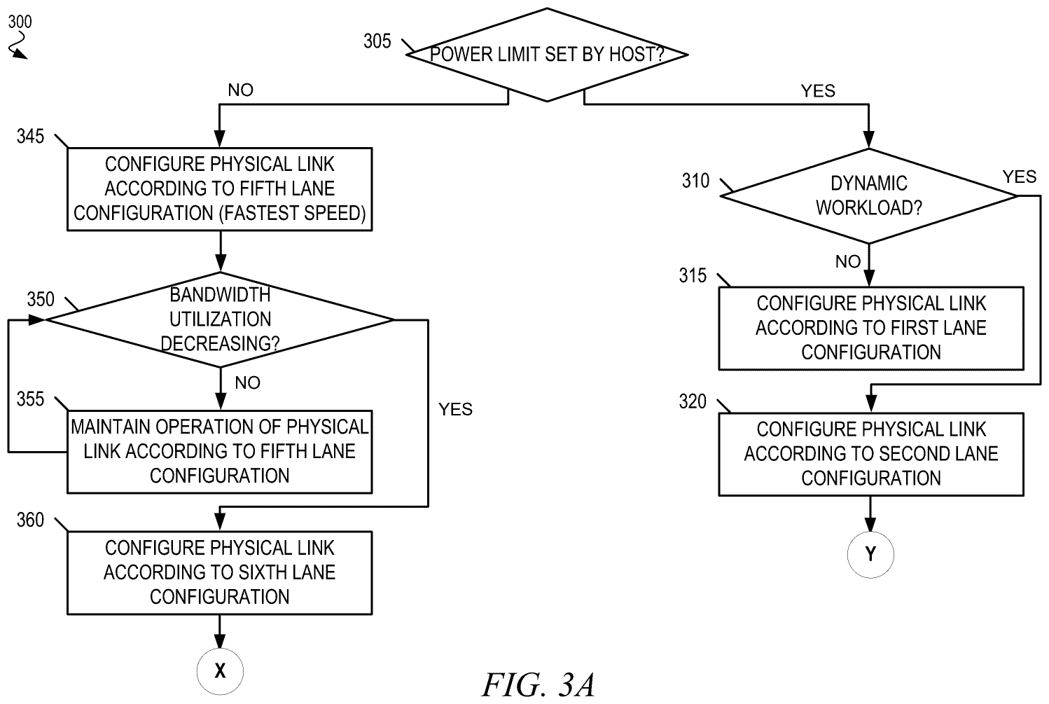

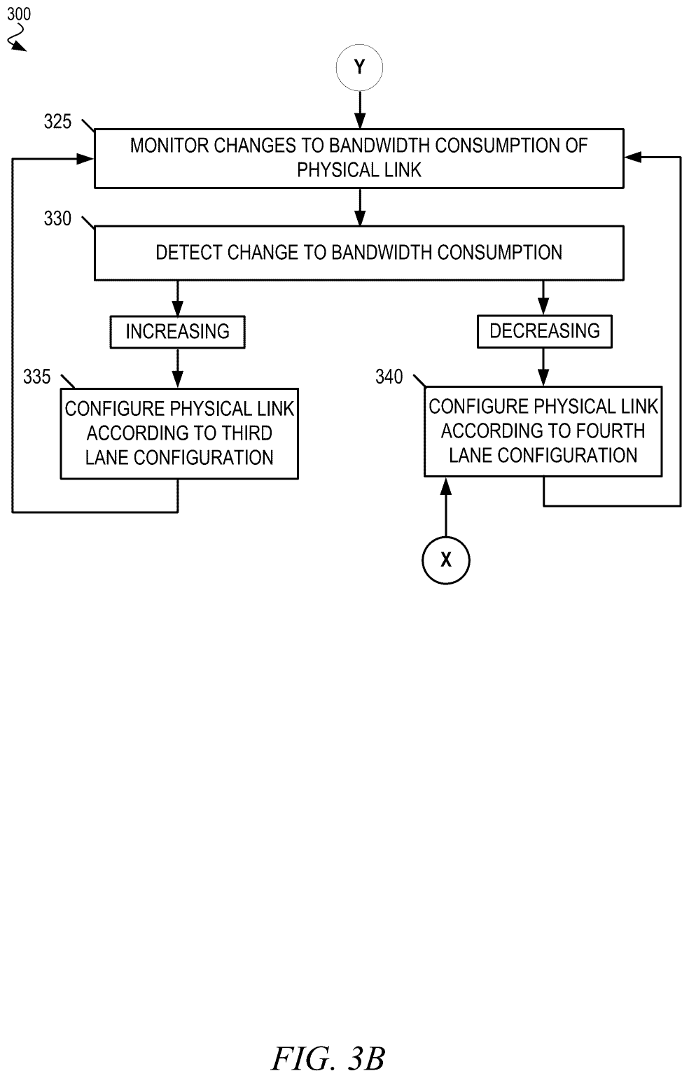

FIG. 3A and FIG. 3B is a flow diagram illustrating an example method for dynamically controlling link speeds in a physical layer of a computing sub-system, in accordance with some embodiments of the present disclosure. The method 300 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some embodiments, the method 300 is performed by the link management component 113 of FIG. 1. Although processes are shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In the following description, reference is made to various link speeds. In some examples, one or more link speeds referenced below may correspond to one or more link speeds referenced above in TABLE 1.

With reference to FIG. 3A, at operation 305, a processing device determines whether a host system (e.g., the host system 120) has set a power limit for a physical link (e.g., the physical host interface 111) between the host system and a computing sub-system (e.g., the memory sub-system 110). The physical link includes a set of lanes. In an example, the host system may establish a power limit to constrain the power consumption of the physical link.

If the processing device determines that the host system has set a power limit for the physical link, the method 300 proceeds to operation 310 where the processing device determines whether a workload served by the physical link is dynamic. That is, the processing device determines whether the bandwidth utilization of the physical link is expected to change. If the processing device determines, at operation 310, that the workload is not dynamic, the processing device, at operation 315, configures the physical link according to a first lane configuration. In configuring the physical link according to the first lane, the processing device configures each of the multiple lanes to operate at a first link speed. The first link speed is determined based on a ratio of power and performance. For example, in determining the first link speed, the processing device determines the link speed that provides the highest power/performance ratio for the physical link at the power limit set by the host system.

If the processing device determines that the workload is dynamic (at operation 310), the processing device configures the physical link according to a second lane configuration, at operation 320. In configuring the physical link according to the second lane configuration, the processing device disables a first portion of the lanes (e.g., comprising one or more lanes) and configures a second portion of the lanes (e.g., comprising one or more lanes) to operate (to serve traffic) at a second link speed. The second link speed is determined based on a ratio of power and performance. For example, in determining the second link speed for the second portion of the multiple lanes, the processing device determines the link speed that provides the highest power/performance ratio for the physical link at the power limit set by the host system.

With reference to FIG. 3B, at operation 325, the processing device monitors changes to the consumption of the physical link's bandwidth (also referred to herein as the “bandwidth utilization of the physical link”). In an example, the processing device monitors the traffic being served by the physical link to monitor for changes to bandwidth utilization. In another example, the processing device monitors communications from the host system that indicate changes to bandwidth utilization. The processing device detects a change to the bandwidth utilization of the physical link, at operation 330. In an example, the processing device detects the change to bandwidth utilization based on an indication of the change to the bandwidth utilization received from the host system. In another example, the processing device detects the change to the bandwidth utilization based on monitoring the traffic served by the physical link.

If the bandwidth utilization of the physical link is increasing, the processing device configures the physical link according to a third lane configuration, at operation 335. In configuring the physical link according to the third lane configuration, the processing device configures a first portion of lanes that are idle (e.g., the first portion of lanes that are disabled at operation 320) according to a third link speed that is higher than the current link speed of a second portion of the lanes (e.g., the second link speed) that are serving traffic, and the processing device disables the second portion of the lanes of the physical link.

If the bandwidth utilization of the physical link is decreasing, the processing device configures the physical link according to a fourth lane configuration, at operation 340. In configuring the physical link according to the fourth lane configuration, the processing device configures a first portion of lanes that are idle (e.g., the first portion of lanes that are disabled at operation 320) according to a fourth link speed that is lower than the current link speed of a second portion of the lanes (e.g., the second link speed) that are serving traffic and the processing device disables the second portion of the lanes of the physical link.

Subsequent to operations 335 and 340, the method 300 returns to the operation 325 where the processing device monitors for changes in bandwidth utilization of the physical link. Thus, it shall be understood that the processing device continuously monitors for changes to the bandwidth utilization of the physical link and dynamically adjusts lane speeds of the physical link in accordance with the changes to the bandwidth utilization. That is, based on determining that the bandwidth utilization for the physical link is increasing, the processing device, at each iteration of operation 335, configures a first portion of lanes (idle lanes) to serve traffic at a higher speed than the current speed at which the second portion of lanes (active lanes) are serving traffic; the processing device then disables the second portion of lanes. Conversely, based on determining that the bandwidth utilization for the physical link is decreasing, the processing device, at each iteration of operation 340, configures a first portion of lanes (idle lanes) to serve traffic at a lower speed than the current speed at which the second portion of lanes (active lanes) are serving traffic; the processing device then disables the second portion of lanes. Hence, although the lane configurations have been described as being “first,” “second,” “third,” etc., these terms are merely labels to convey distinctions between lane configurations and are not intended to limit any particular lane configuration or specific lane speeds associated therewith.

With returned reference to operation 305 of FIG. 3A, if the processing device determines that the host system has not set a power limit for the physical link, the method 300 proceeds to operation 345 where the processing device configures the multiple lanes of the physical link according to a fifth lane configuration. In configuring the multiple lanes according to the fifth lane configuration, the processing device configures each lane to operate at a fifth link speed, which is the fastest link speed at which the multiple lanes are capable of operating.

At operation 350, the processing devices determines whether the bandwidth utilization of the physical link is decreasing. If the processing device does not detect a decrease in the bandwidth utilization of the physical link, the processing device maintains the physical link according to the fifth lane configuration (operation 355). That is, in the absence of a decrease to the bandwidth utilization of the physical link, the processing device maintains the operation of the multiple lanes at the fastest link speed.

If the processing device detects a decrease to the bandwidth utilization of the physical link, the processing device configures the physical link according to a sixth lane configuration, at operation 360. In configuring the physical link according to the sixth lane configuration, the processing device disables a first portion of the multiple lanes while maintaining the operation of a second portion of the lanes at the fifth link speed (the highest link speed). Subsequent to operation 360, the method 300 proceeds to operation 340, discussed above.

Described implementations of the subject matter can include one or more features, alone or in combination as illustrated below by way of example.

Example 1. A computing sub-system comprising: a physical link comprising a set of lanes configured according to a first lane configuration, the first lane configuration including a first portion of the set of lanes being disabled and a second portion of the set of lanes serving traffic at a first link speed; and a processing device, operatively coupled to the physical link to perform operations comprising: detecting a change to bandwidth utilization of the physical link; and in response to detecting the change to bandwidth utilization of the physical link, configuring the set of lanes according to a second lane configuration, the configuring of the set of lanes according to the second lane configuration comprising: configuring the first portion of the set of lanes to serve traffic at a second link speed; and disabling the second portion of the set of lanes.

Example 2. The computing sub-system of Example 1, wherein: detecting the change to the bandwidth utilization of the physical link comprising detecting an increase to the bandwidth utilization of the physical link; and the second link speed is higher than the first link speed.

Example 3. The computing sub-system of any one or more of Examples 1 or 2, wherein: detecting the change to the bandwidth utilization of the physical link comprising detecting a decrease to the bandwidth utilization of the physical link; and the second link speed is lower than the first link speed.

Example 4. The computing sub-system of any one or more of Examples 1-3, wherein the operations comprise: prior to detecting the change to the bandwidth utilization of the physical link, determining whether a power limit for the physical link has been set by a host system; and based on determining no power limit has been set for the physical link, configuring the set of lanes according to a third lane configuration, the configuring of the set of lanes according to the third lane configuration comprising configuring each lane in the set of lanes to serve traffic at third link speed, the third link speed being a fastest link speed for the set of lanes in the physical link.

Example 5. The computing sub-system of any one or more of Examples 1-4, wherein: the change to the bandwidth utilization of the physical link is a first change; the operations comprise: prior to detecting the first change to the bandwidth utilization, detecting a second change to the bandwidth utilization of the physical link, the second change comprising a decrease to the bandwidth utilization; and based on detecting the second change to the bandwidth utilization, configuring the set of lanes according to the first lane configuration.

Example 6. The computing sub-system of any one or more of Examples 1-5, wherein the operations comprise: prior to detecting the change to the bandwidth utilization of the physical link, determining a power limit for the physical link has been set by a host system; determining a workload communicated over the physical link is dynamic; and based on determining the power limit for the physical link has been set by the host system and determining that the workload communicated over the physical link is dynamic, configuring the set of lanes according to the first lane configuration.

Example 7. The computing sub-system of any one or more of Examples 1-6, wherein configuring the set of lanes according to the first lane configuration comprises: determining the first link speed based on a power and performance ratio at the power limit set by the host, the determining the first link speed comprising identifying a link speed that provides a highest power and performance ratio; and configuring the second portion of the set of lanes to serve traffic at the first link speed.

Example 8. The computing sub-system of any one or more of Examples 1-7, comprising a memory device, wherein the physical link couples the computing sub-system to a host system, the traffic served by the second portion of the set of lanes including data read from the memory device based on a command received from the host system.

Example 9. The computing sub-system of any one or more of Examples 1-8, wherein the physical link comprises a peripheral component interconnect (PCI) express (PCIe) interface.

Example 10. A method comprising: detecting, by a processing device, a change to bandwidth utilization of a physical link, the physical link including a set of lanes configured according to a first lane configuration, the first lane configuration including a first portion of the set of lanes being disabled and a second portion of the set of lanes serving traffic at a first link speed; in response to detecting the change to bandwidth utilization of the physical link, configuring, by the processing device, the set of lanes according to a second lane configuration, the configuring of the set of lanes according to the second lane configuration comprising: configuring the first portion of the set of lanes to serve traffic at a second link speed; and disabling the second portion of the set of lanes.

Example 11. The method of Examples 10, wherein: detecting the change to the bandwidth utilization of the physical link comprising detecting an increase to the bandwidth utilization of the physical link; and the second link speed is higher than the first link speed.

Example 12. The method of any one or more of Examples 10 or 11, wherein: detecting the change to the bandwidth utilization of the physical link comprising detecting a decrease to the bandwidth utilization of the physical link; and the second link speed is lower than the first link speed.

Example 13. The method of any one or more of Examples 10-12, comprising: prior to detecting the change to the bandwidth utilization of the physical link, determining whether a power limit for the physical link has been set by a host system; and based on determining no power limit has been set for the physical link, configuring the set of lanes according to a third lane configuration, the configuring of the set of lanes according to the third lane configuration comprising configuring each lane in the set of lanes to serve traffic at third link speed, the third link speed being a fastest link speed for the set of lanes in the physical link.

Example 14. The method of any one or more of Examples 10-13, wherein: the change to the bandwidth utilization of the physical link is a first change; the method further comprises: prior to detecting the first change to the bandwidth utilization, detecting a second change to the bandwidth utilization of the physical link, the second change comprising a decrease to the bandwidth utilization; and based on detecting the second change to the bandwidth utilization, configuring the set of lanes according to the first lane configuration.

Example 15. The method of any one or more of Examples 10-14, further comprising: prior to detecting the change to the bandwidth utilization of the physical link, determining a power limit for the physical link has been set by a host system; determining a workload communicated over the physical link is dynamic; and based on determining the power limit for the physical link has been set by the host system and determining that the workload communicated over the physical link is dynamic, configuring the set of lanes according to the first lane configuration.

Example 16. The method of any one or more of Examples 10-15, wherein configuring the set of lanes according to the first lane configuration comprises: determining the first link speed based on a power and performance ratio at the power limit set by the host, the determining the first link speed comprising identifying a link speed that provides a highest power and performance ratio; and configuring the second portion of the set of lanes to serve traffic at the first link speed.

Example 17. The method of any one or more of Examples 10-16, wherein the physical link couples a computing sub-system to a host system, wherein the traffic served by the second portion of the set of lanes includes data read from a memory device based on a command received from the host system.

Example 18. The method of any one or more of Examples 10-17, wherein the physical link comprises a peripheral component interconnect (PCI) express (PCIe) interface.

Example 19. A computer-readable storage medium comprising instructions that, when executed by a processing device, configure the processing device to perform operations comprising: detecting a change to bandwidth utilization of a physical host interface that communicatively couples a host system to a computing sub-system, the physical host interface including a set of lanes configured according to a first lane configuration, the first lane configuration including a first portion of the set of lanes being disabled and a second portion of the set of lanes serving traffic at a first link speed; and in response to detecting the change to bandwidth utilization of the physical host interface, configuring the set of lanes according to a second lane configuration, the configuring of the set of lanes according to the second lane configuration comprising: configuring the first portion of the set of lanes to serve traffic at a second link speed; and disabling the second portion of the set of lanes.

Example 20. The computer-readable storage medium of Example 19, wherein the operations further comprise: prior to detecting the change to the bandwidth utilization of the physical host interface, determining whether a power limit for the physical host interface has been set by a host system; based on determining no power limit has been set for the physical host interface, configuring the set of lanes according to a third lane configuration, the configuring of the set of lanes according to the third lane configuration comprising configuring each lane in the set of lanes to serve traffic at third link speed, the third link speed being a fastest link speed for the set of lanes in the physical link; detecting a decrease to the bandwidth utilization of the physical host interface; and based on detecting the decrease to the bandwidth utilization, configuring the set of lanes according to the first lane configuration.

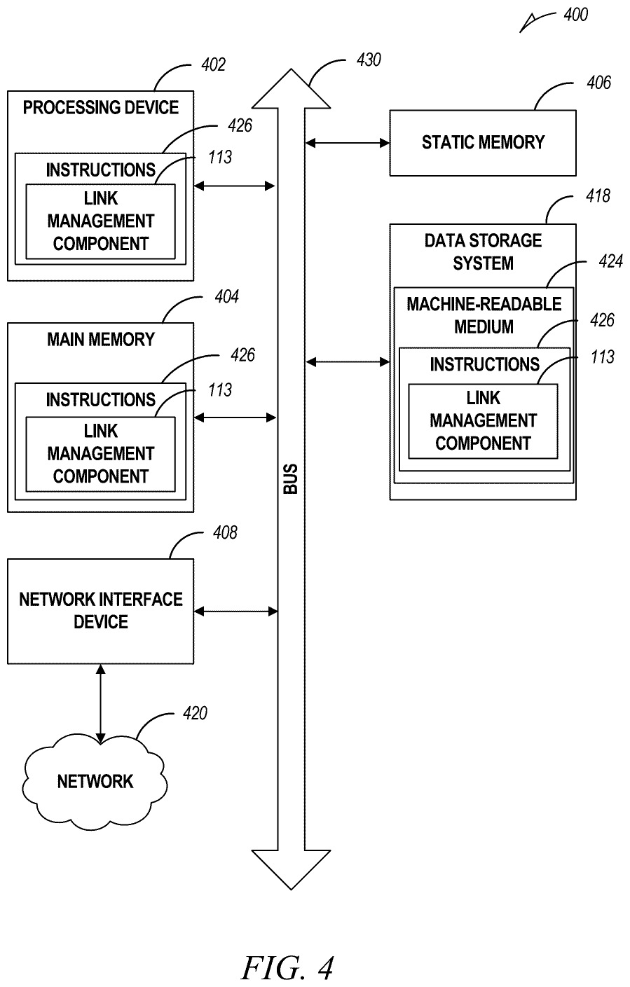

FIG. 4 illustrates an example machine in the form of a computer system within which a set of instructions can be executed for causing the machine to perform any one or more of the methodologies discussed herein. FIG. 4 illustrates an example machine of a computer system 400 within which a set of instructions, for causing the machine to perform any one or more of the methodologies discussed herein, can be executed. In some embodiments, the computer system 400 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the link management component 113 of FIG. 1). In alternative embodiments, the machine can be connected (e.g., networked) to other machines in a local area network (LAN), an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., ROM, flash memory, DRAM such as SDRAM or RDRAM, etc.), a static memory 406 (e.g., flash memory, static random access memory (SRAM), etc.), and a data storage system 418, which communicate with each other via a bus 430.

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an ASIC, a FPGA, a digital signal processor (DSP), network processor, or the like. The processing device 402 is configured to execute instructions 426 for performing the operations and steps discussed herein. The computer system 400 can further include a network interface device 408 to communicate over a network 420.

The data storage system 418 can include a machine-readable storage medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable storage medium 424, data storage system 418, and/or main memory 404 can correspond to the memory sub-system 110 of FIG. 1.

In one embodiment, the instructions 426 include instructions to implement functionality corresponding to a link management component (e.g., the link management component 113 of FIG. 1). While the machine-readable storage medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a ROM, RAM, magnetic disk storage media, optical storage media, flash memory components, etc.

In the foregoing specification, embodiments of the disclosure have been described with reference to specific example embodiments thereof. It will be evident that various modifications can be made thereto without departing from the broader scope of embodiments of the disclosure as set forth in the following claims. The specification and drawings are, accordingly, to be regarded in an illustrative sense rather than a restrictive sense.

What is claimed is:

1. A computing sub-system comprising:
a physical link comprising a set of lanes configured according to a first lane configuration, the first lane configuration including a first portion of the set of lanes being disabled and a second portion of the set of lanes serving traffic at a first link speed; and
a processing device, operatively coupled to the physical link to perform operations comprising:
detecting a change to bandwidth utilization of the physical link; and
in response to detecting the change to bandwidth utilization of the physical link, configuring the set of lanes according to a second lane configuration, the configuring of the set of lanes according to the second lane configuration comprising:
configuring the first portion of the set of lanes to serve traffic at a second link speed; and
disabling the second portion of the set of lanes.

2. The computing sub-system of claim 1, wherein:
detecting the change to the bandwidth utilization of the physical link comprising detecting an increase to the bandwidth utilization of the physical link; and
the second link speed is higher than the first link speed.

3. The computing sub-system of claim 1, wherein:
detecting the change to the bandwidth utilization of the physical link comprising detecting a decrease to the bandwidth utilization of the physical link; and
the second link speed is lower than the first link speed.

4. The computing sub-system of claim 1, wherein the operations comprise:
prior to detecting the change to the bandwidth utilization of the physical link, determining whether a power limit for the physical link has been set by a host system; and
based on determining no power limit has been set for the physical link, configuring the set of lanes according to a third lane configuration, the configuring of the set of lanes according to the third lane configuration comprising configuring each lane in the set of lanes to serve traffic at third link speed, the third link speed being a fastest link speed for the set of lanes in the physical link.

5. The computing sub-system of claim 4, wherein:
the change to the bandwidth utilization of the physical link is a first change;
the operations comprise:
prior to detecting the first change to the bandwidth utilization, detecting a second change to the bandwidth utilization of the physical link, the second change comprising a decrease to the bandwidth utilization; and
based on detecting the second change to the bandwidth utilization, configuring the set of lanes according to the first lane configuration.

6. The computing sub-system of claim 1, wherein the operations comprise:
prior to detecting the change to the bandwidth utilization of the physical link,
determining a power limit for the physical link has been set by a host system;
determining a workload communicated over the physical link is dynamic; and
based on determining the power limit for the physical link has been set by the host system and determining that the workload communicated over the physical link is dynamic, configuring the set of lanes according to the first lane configuration.

7. The computing sub-system of claim 6, wherein configuring the set of lanes according to the first lane configuration comprises:
determining the first link speed based on a power and performance ratio at the power limit set by the host, the determining the first link speed comprising identifying a link speed that provides a highest power and performance ratio; and
configuring the second portion of the set of lanes to serve traffic at the first link speed.

8. The computing sub-system of claim 1, comprising a memory device, wherein the physical link couples the computing sub-system to a host system, the traffic served by the second portion of the set of lanes including data read from the memory device based on a command received from the host system.

9. The computing sub-system of claim 1, wherein the physical link comprises a peripheral component interconnect (PCI) express (PCIe) interface.

10. A method comprising:
detecting, by a processing device, a change to bandwidth utilization of a physical link, the physical link including a set of lanes configured according to a first lane configuration, the first lane configuration including a first portion of the set of lanes being disabled and a second portion of the set of lanes serving traffic at a first link speed;
in response to detecting the change to bandwidth utilization of the physical link, configuring, by the processing device, the set of lanes according to a second lane configuration, the configuring of the set of lanes according to the second lane configuration comprising:
configuring the first portion of the set of lanes to serve traffic at a second link speed; and
disabling the second portion of the set of lanes.

11. The method of claim 10, wherein:
detecting the change to the bandwidth utilization of the physical link comprising detecting an increase to the bandwidth utilization of the physical link; and
the second link speed is higher than the first link speed.

12. The method of claim 10, wherein:
detecting the change to the bandwidth utilization of the physical link comprising detecting a decrease to the bandwidth utilization of the physical link; and
the second link speed is lower than the first link speed.

13. The method of claim 10, comprising:
prior to detecting the change to the bandwidth utilization of the physical link, determining whether a power limit for the physical link has been set by a host system; and
based on determining no power limit has been set for the physical link, configuring the set of lanes according to a third lane configuration, the configuring of the set of lanes according to the third lane configuration comprising configuring each lane in the set of lanes to serve traffic at third link speed, the third link speed being a fastest link speed for the set of lanes in the physical link.

14. The method of claim 13, wherein:
the change to the bandwidth utilization of the physical link is a first change;
the method further comprises:
prior to detecting the first change to the bandwidth utilization, detecting a second change to the bandwidth utilization of the physical link, the second change comprising a decrease to the bandwidth utilization; and
based on detecting the second change to the bandwidth utilization, configuring the set of lanes according to the first lane configuration.

15. The method of claim 10, further comprising:
prior to detecting the change to the bandwidth utilization of the physical link,
determining a power limit for the physical link has been set by a host system;
determining a workload communicated over the physical link is dynamic; and
based on determining the power limit for the physical link has been set by the host system and determining that the workload communicated over the physical link is dynamic, configuring the set of lanes according to the first lane configuration.

16. The method of claim 15, wherein configuring the set of lanes according to the first lane configuration comprises:
determining the first link speed based on a power and performance ratio at the power limit set by the host, the determining the first link speed comprising identifying a link speed that provides a highest power and performance ratio; and
configuring the second portion of the set of lanes to serve traffic at the first link speed.

17. The method of claim 10, wherein the physical link couples a computing sub-system to a host system, wherein the traffic served by the second portion of the set of lanes includes data read from a memory device based on a command received from the host system.

18. The method of claim 10, wherein the physical link comprises a peripheral component interconnect (PCI) express (PCIe) interface.

19. A computer-readable storage medium comprising instructions that, when executed by a processing device, configure the processing device to perform operations comprising:
detecting a change to bandwidth utilization of a physical host interface that communicatively couples a host system to a computing sub-system, the physical host interface including a set of lanes configured according to a first lane configuration, the first lane configuration including a first portion of the set of lanes being disabled and a second portion of the set of lanes serving traffic at a first link speed; and
in response to detecting the change to bandwidth utilization of the physical host interface, configuring the set of lanes according to a second lane configuration, the configuring of the set of lanes according to the second lane configuration comprising:
configuring the first portion of the set of lanes to serve traffic at a second link speed; and
disabling the second portion of the set of lanes.

20. The computer-readable storage medium of claim 19, wherein the operations further comprise:
prior to detecting the change to the bandwidth utilization of the physical host interface, determining whether a power limit for the physical host interface has been set by a host system;
based on determining no power limit has been set for the physical host interface, configuring the set of lanes according to a third lane configuration, the configuring of the set of lanes according to the third lane configuration comprising configuring each lane in the set of lanes to serve traffic at third link speed, the third link speed being a fastest link speed for the set of lanes in the physical link;
detecting a decrease to the bandwidth utilization of the physical host interface; and
based on detecting the decrease to the bandwidth utilization, configuring the set of lanes according to the first lane configuration.
